(19) United States
(12) Patent Application Publication
(10) Pub. No.: US 2009/0213936 A1
(43) Pub. Date: Aug. 27, 2009

(54) ENCODING DEVICE

(75) Inventors: Takashi HAMANO, Kawasaki (JP); Teruyuki Sato, Kawasaki (JP); Ryuta Tanaka, Kawasaki (JP); Atsuko Tada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/368,499

(22) Filed: Feb. 10, 2009

(30) Foreign Application Priority Data
Feb. 21, 2008 (JP) 2008-040635

(51) Int. Cl. H04N 7/26

(52) U.S. Cl. 375/240.16; 375/E07.123

(57) ABSTRACT

An encoding method for encoding a sequence of image frames, the encoding method includes the steps of: selecting an image frame to be deleted from the plurality of image frames; detecting motion vectors between a pair of image frames that are either previous to and next to the selected image frames; deleting the selected image frame if the detected motion vectors meet a predetermined condition; and encoding remainder of the image frames in which any of the image frames has been deleted by the deleting step.

### CROSS-REFERENCE TO RELATED APPLICATION

This application is based upon and claims the benefit of priority of the prior Japanese Patent Application No. 2008-040635, filed on Feb. 21, 2008, the entire contents of which are incorporated herein by reference.

### FIELD

A certain aspect of the embodiments discussed herein is related to an encoding device.

### BACKGROUND

Conventionally, in a moving picture encoding device, as means for restricting the amount of encoded data to a predetermined bit rate, there has been proposed a controlling method of decreasing the amount of encoded data by pulling down frames 90 of input images on the basis of encoding process 91 and the controlling 92 (see FIG. 9). When this method is used, since the number of bits allocated to respective frames is increased in comparison with the case where no frames are pulled down, the image quality per frame is relatively high. However, it is well known that due to blank time between frames, motions become jerky.

Thus, there has been adopted a technique for controlling the pulled down amount on the basis of the degree of difficulty of encoding in order to reduce the number of frames to be pulled down. FIG. 10 illustrates a specific example of a manner of controlling scene-skipping (frame-pull-down) performed by an encoding processing unit on the basis of the degree of difficulty of encoding 100. In this example, the frame-pull-down amount is controlled in accordance with the degree of difficulty of encoding 100.

In the example illustrated in FIG. 10, the degree of difficulty of encoding 100 is determined by comparing the actual amount of encoding occurrence information with a target bit rate using the encoding processing unit and is classified into one of three levels of “low, moderate and high” levels in accordance with the degree of severity of frame-pull-down in controlling of encoding 101.

On the other hand, as means for reducing jerkiness due to the frame-pull-down and characteristics of a display panel (a liquid crystal panel or the like) installed in a display device (or a decoding device), there is a well-known frame interpolating method 111 of generating an intermediate frame from frames positioned in previous and next thereby displaying smoothly the movements of images trough decoding process 110 (see FIG. 11).

In addition, such examples of the prior art in which frames which have been pulled-down by an encoding device are interpolated by a decoding device in relation to encoding and decoding processes are disclosed in Japanese Laid-Open Patent Application Publication Nos. 2006-270294 and 10-215458.

Japanese Laid-Open Patent Application Publication No. 2006-270294 discloses a technique in which encoding means for interpolation use adapted to encode motion vectors of frames which have been pulled-down by encoding is incorporated into a moving picture encoding device, in addition to encoding means for ordinary use and a moving picture decoding device synthesizes the pulled-down frames using encoded data for interpolation. Japanese Laid-Open Patent Application Publication No. 10-215458 discloses a method in which a moving picture decoding device interpolates a image frame using the motion vectors of frames in previous and next of the pulled-down image frame.

However, if data for interpolating the frame is to be added as disclosed in Japanese Laid-Open Patent Application Publication No. 2006-270294, it will become necessary to add the encoded data for interpolations notwithstanding the fact that the amount of encoded data has been reduced by pulled down the frames. As a result, such a problem occurs that the number of bits which can be used for encoding is reduced and hence the in age quality per frame is deteriorated.

Likewise, the technique disclosed in Japanese Laid-Open Patent Application Publication No. 10-215458 has such a problem that frame-pulled-down performed by the moving picture encoding device is controlled regardless of whether frame-interpolation effectively works in the decoding device, so that the interpolation does not always effectively work upon decoding.

### SUMMARY

According to an aspect of an embodiment, an encoding method for encoding a sequence of image frames, the encoding method includes the steps of: selecting an image frame to be deleted from the plurality of image frames; detecting motion vectors between a pair of image frames that are either previous to and next to the selected image frames; deleting the selected image frame if the detected motion vectors meet a predetermined condition; and encoding remainder of the image frames in which any of the image frames has been deleted by the deleting step.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a general structure of an encoding device according to the present invention;

FIG. 2 is a diagram illustrating a system to which the encoding device according to the present invention is applied;

FIG. 3 is a flowchart illustrating processing operations of the encoding device according to the present invention;

FIG. 4 is a diagram illustrating a structure for judging the effectiveness of interpolation from variations in motion vectors;

FIG. 5 is a diagram illustrating a manner of judging the effectiveness of interpolation from the variations in the motion vectors;

FIG. 6 is a diagram illustrating a structure for judging the effectiveness of interpolation by comparing a pull-down frame with an interpolation frame;

FIG. 7 is a diagram illustrating a manner in which the effectiveness of interpolation is judged by comparing the pulled down frame and the interpolation frame;

FIG. 8 is a diagram illustrating a controlling operation for controlling pulling down;

FIG. 9 is a flowchart illustrating a known conventional encoding device;

FIG. 10 is a diagram illustrating a conventional frame-pull-down controlling operation; and

FIG. 11 is a diagram illustrating a conventional frame interpolating operation.

### DESCRIPTION OF EMBODIMENTS

Next, embodiments of the image encoding device, the image encoding method and the image encoding program will be described in detail with reference to the accompanying drawings.

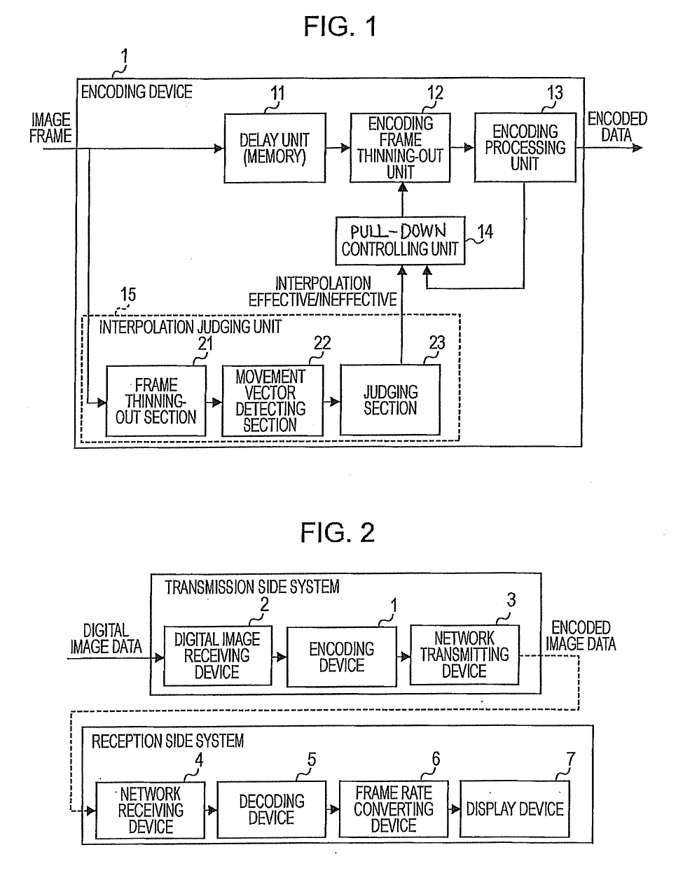

FIG. 1 is a diagram illustrating a general structure of the encoding device according to the present invention. The encoding device 1 illustrated in FIG. 1 constitutes a part of a transmission side system, as illustrated in FIG. 2. In this system, a digital image receiving device 2 performs processes of receiving and encoding a digital image received from the outside. Then, the encoded image data is transmitted from a network transmitting device 3.

In a receive side system, a network receiving device 4 receives the encoded image data, then a decoding device 5 decodes the received encoded image data, a frame rate converting device 6 converts the frame rate thereof and a display device 7 displays the frame-rate-converted data thereon.

As illustrated in FIG. 1, the encoding device 1 includes therein a delay unit 11, an encoding frame pull-down unit 12, an encoding processing unit 13, a pull-down controlling unit 14 and an interpolation judging unit 15. The delay unit 11 includes a memory for temporarily storing input image data, that is, a plurality of successive image frames and is adapted to delay pull-down and encoding of image frames for a time period required for performance of later-described processes by the interpolation judging unit 15 and the pull-down controlling unit 14.

The encoding frame pull-down unit 12 is a processing unit for pulling down a frame from the successive image frames to reduce the number of frames. Whether the pulling-down is to be executed is determined under the later-described control of the pulling-down controlling unit 14. In the case that the pulling-down is executed, the encoding frame pulling-out unit 12 outputs the successive image frames from which the image frame to be pulled-down has been deleted to later stages. While, in the case that no pulling-down is to be executed, the encoding frame pulling-down unit 12 outputs the original successive image frames to the later stages as they are.

The encoding processing unit 13 is a processing unit for encoding and outputting the successive image frames output from the encoding frame pulling-down unit 12. In addition, the encoding processing unit 13 outputs the actual amount of encoding occurrence information relative to a target bit rate as the degree of difficulty of encoding to the pulling-down controlling unit 14.

The interpolation judging unit 15 is a judging unit for performing the pulling-down on the input successive image frames, thereafter judging whether an interpolating process will effectively work on the successive image frames from which the candidate frame has been pulled-down and outputting a result of judgment as interpolation effectiveness information.

The pulling-down controlling unit 14 generates and outputs a signal indicating whether the pulling-down is to be executed using the result of judgment by the interpolation judging unit 15 and the degree of difficulty of encoding by the encoding processing unit 13 to the encoding frame pulling-down unit 12 to control the frame-pulling-down.

The interpolation judging unit 15 includes therein a frame pulling-down section 21, a motion vector detecting section 22 and a judging section 23. The frame pulling-down section 21 is a processing section for executing a frame-pulling-down process on the input successive image frames. The motion vector detecting section 22 performs a process of detecting motion vectors from the image frames from which the candidate frame has been pulled-down. The judging section 23 judges whether frame-interpolation will effectively work upon decoding using the obtained motion vectors and outputs a result of judgment to the pulling-down controlling unit 14.

In other words, the interpolation judging unit 15 prepares successive image frames which would be received by the decoding device in the case that it is assumed that the encoding frame pulling-down unit 12 has pulled-down the candidate frame by executing the frame-pulling-down process by means of its frame pulling-down section 21 and evaluates whether an interpolating process performed by the encoding device will effectively work on the basis of the motion vectors between the prepared successive image frames.

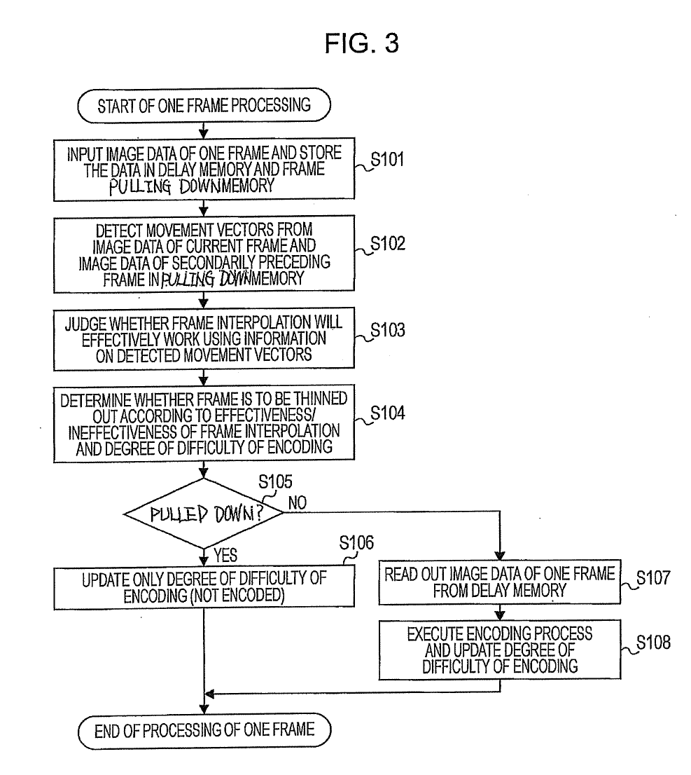

Next, processing operations performed by the encoding device 1 will be described with reference to FIG. 3. First, the encoding device 1 inputs thereinto image data of one frame and stores the data in the memory of the delay unit 11 and a memory of the frame pulling-down section 21 (a step S101).

Then, the motion vector detecting section 22 reads out image data of the current frame and image data of the secondarily preceding frame from the memory for pulling-down use of the frame pulling-down section 21 to detect the motion vectors between the image data (a step S102).

Then, the judging section 23 uses information on the detected motion vectors to judge, in the case that image data of the immediately preceding frame (the image data of the candidate frame to be pulled-down) has been pulled-down, whether it is an image on which the frame-interpolation will effectively work (a step S103). Next, the pulling-down controlling unit 14 determines whether the pulling-down is to be executed on the basis of the effectiveness/non-effectiveness of the frame-interpolation and the degree of difficulty of encoding (a step S104).

As a result, in the case that it is determined that the candidate frame of pulling-down is not to be pulled-down (No at step S105), the encoding frame pulling-down unit 12 reads out the image data of one frame (the data of the firstly preceding frame) from the memory of the delay unit 11 (step S107) and the encoding processing unit 13 performs the encoding process on the data and then updates the degree of difficulty of encoding (step S108), thereby completing the processing of one frame.

On the other hand, in the case that it is determined that the candidate frame of pulling-down is to be pulled-down (Yes at step S105), only the degree of difficulty of encoding is updated without encoding that frame (a step S106), thereby completing the processing of one frame. Specifically, the frame determined to be pulled-down is not read out from the memory of the delay unit 11, but finally disappears with the following frame overwritten thereon.

As described above, the present invention mainly features controlling the frame-pulling-down operation by the dynamic image encoding device after retrieval of the motion vectors for frames decoded by the decoding device and consideration of whether a process of interpolating a frame to be pulled-down executed on the basis of the retrieved motion vectors will effectively work (the effectiveness of interpolation).

Then, owing to the above mentioned feature, it becomes possible to predict a frame on which the frame interpolating process performed by the display device (the decoding device) effectively works and to realize the encoding of frames after this frame has been preferentially pulled-down. As a result, the reduction in the number of encoded bits due to extra addition of encoded data for interpolation can be avoided and the generation of encoded data on which the frame-interpolation is apt to effectively work can be realized even in the case that the frame-interpolation is performed by the decoding device alone.

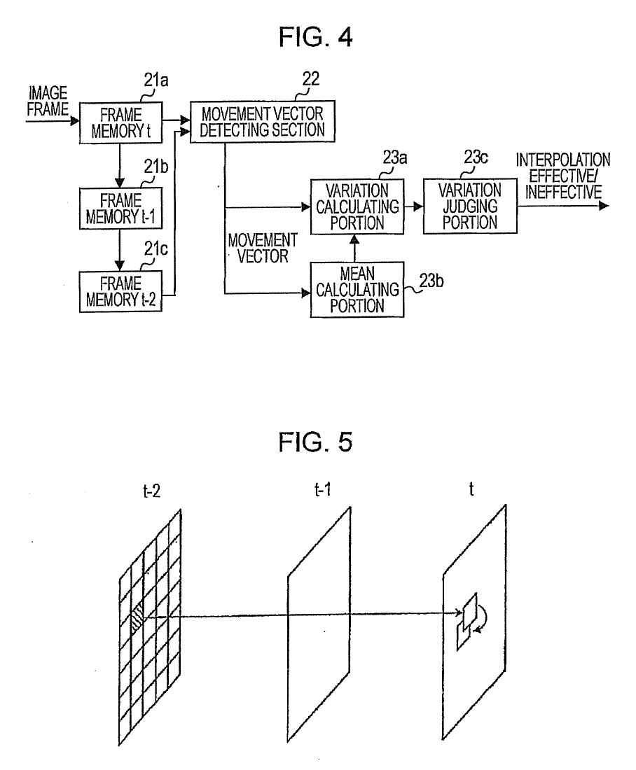

Next, with reference to FIG. 4, a specific structural example of the interpolation judging unit 15 will be described. In the structural example illustrated in FIG. 4, frame memories 21a, 21b and 21c constitute the frame pulling-down section 21 and a variation calculating portion 23a, a mean calculating portion 23b and a variation judging portion 23c constitute the judging section 23.

In the structure mentioned above, a frame t or data of the latest image frame, a frame t-1 or data of the immediately preceding image frame and a frame t-2 or data of the secondarily preceding image frame are held respectively in the frame memories 21a, 21b and 21c.

The motion vector detecting section 22 detects the motion vectors in units of a predetermined number of pixels from images of the frames t and t-2 to be encoded in the case that the frame t-1 has been pulled-down. The mean calculating portion 23b calculates the mean value of the motion vectors of one frame from the detected motion vectors input thereinto.

The variation calculating portion 23a calculates the variation (the error) in each vector from the mean vector. The variation judging portion 23c judges the variation in the motion vector within the frame from the magnitude of the variation calculated.

More specifically, the variation calculating portion 23a calculates the difference square sum of each of horizontal and vertical vectors which have been calculated in units of the predetermined number of pixels from the mean value of each of the horizontal and vertical vectors, for example, as illustrated in FIG. 5.

The variation judging portion 23c calculates, for example, the occurrence probability that the above mentioned difference square sum is below a predetermined threshold value and generates an output indicating that the interpolation will be effective in the case that the occurrence probability exceeds a fixed value or an output indicating that the interpolation will not be effective in other cases.

As mentioned above, in the structure illustrated in FIG. 4, in the case that the interpolating process has been performed on a decoded frame by the display device (the decoding device), whether it is an image on which the frame-interpolation will effectively work is judged as a prediction on the basis of the variation in the motion vector within the frame, focusing on a vertically, horizontally and obliquely scrolling image over the entire frame for which the frame interpolating process is relatively apt to be realized.

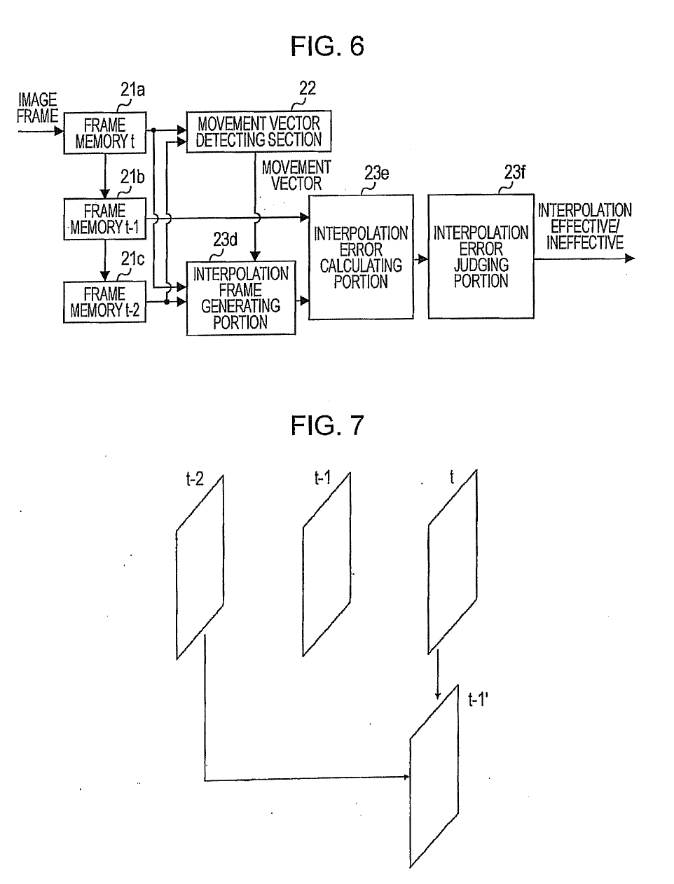

FIG. 6 illustrates another structural embodiment of the interpolation judging unit 15. In the structural embodiment illustrated in FIG. 6, the frame memories 21a, 21b and 21c constitute the frame pulling-down section 21 and an interpolation frame generating portion 23d, an interpolation error calculating portion 23e, and an interpolation error judging portion 23f constitutes the judging section 23.

In this structure, the motion vector detecting section 22 detects the motion vectors in units of the predetermined number of pixels from the images of the frames t and t-2 to be encoded in the case that the frame t-1 has been pulled-down, and thereafter the interpolation frame generating portion 23d generates an interpolation frame t-1′ using the motion vectors as illustrated in FIG. 7.

Then, the interpolation error calculating portion 23e calculates an interpolation error between the frame t-1 to be pulled-down and the interpolation frame t-1′ and the error judging portion 23f judges whether the interpolation will be effective from the magnitude of the calculated interpolation error.

In this case, the interpolation error calculating portion 23e calculates the difference square sum at the same position, for example, between the interpolation frame and the pulled-down frame. The interpolation error judging portion 23f generates an output indicating that the interpolation will be effective, for example, in the case that the difference square sum is below the predetermined threshold value or generates an output indicating that the interpolation will not be effective in other cases.

As described above, in the structure illustrated in FIG. 6, in the case that the interpolating process has been performed on the decoded frame by the display device (the decoding device), an interpolation error when the pulled-down frame has been interpolated is acquired from the frames in front of and behind the pulled-down frame by the encoding device and then whether it is an image on which the frame-interpolation will effectively work is judged, as a prediction, on the basis of the acquired interpolation error.

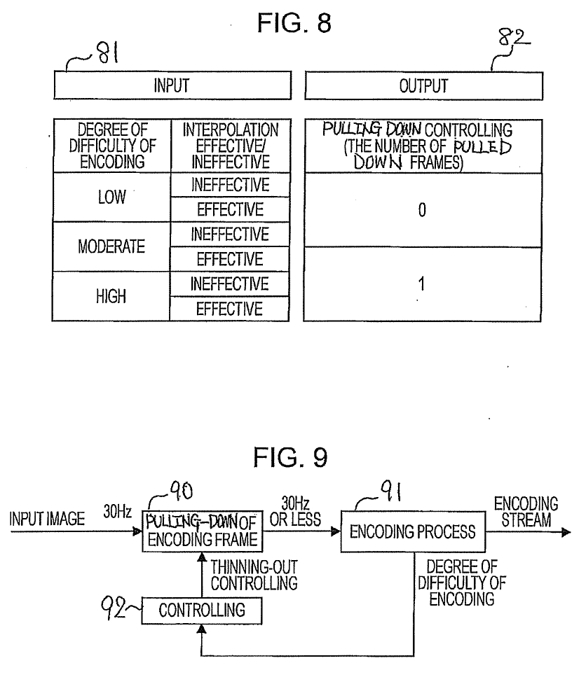

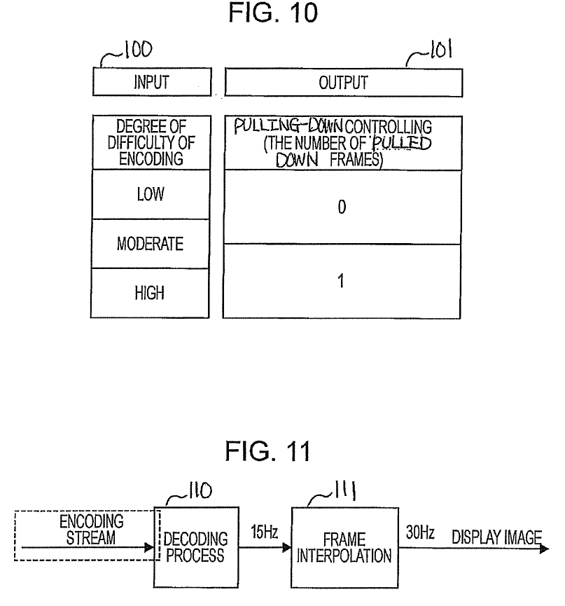

Next, with reference to FIG. 8, a controlling operation performed by the pulling-down controlling unit 14 will be described. The pulling-down controlling unit 14 receives as inputs the degree of difficulty of encoding 81 as information for controlling the pulling-down from the encoding processing unit 13 and information indicative of the effectiveness/non-effectiveness of the interpolation from the interpolation judging unit 15 and outputs the number of pulled-down frames 82 as frame-pulling-down controlling information in accordance with a table illustrated in FIG. 8.

The degree of difficulty of encoding illustrated in FIG. 8 is determined by the encoding processing unit 13 by comparing the actual amount of encoding occurrence information with the target bit rate and is constituted by three levels of “low, moderate and high” levels in accordance with the degree of severity of frame-pulling-down in the encoding controlling. The information indicative of the effectiveness/non-effectiveness of the interpolation is generated by the methods described, for example, with reference to FIGS. 4 and 6.

In the case that the degree of difficulty of encoding is “low”, even though the encoding is continuously performed in this state, the target bit rate is satisfied, so that no frame-pulling-down is performed regardless of whether the interpolation is judged to be effective.

In the case that the degree of difficulty of encoding is “high”, since there is a possibility that the encoding cannot be continuously performed (the encoding occurrence information amount cannot be restricted to the target bit rate), the frame-pulling-down is performed regardless of whether the interpolation is judged to be effective.

On the other hand, in the case that the degree of difficulty of encoding is “moderate” and it is predicted that the frame-interpolation will effectively work, the frame-pulling-down is positively performed. As a result, the frame-interpolation works so as to reduce the encoding occurrence information amount and to ensure a sufficient amount of information which can be allocated to succeeding scenes.

As described above, in the encoding device according to this embodiment, in the case that the interpolating process has been performed on the decoded frame by the display device (the decoding device), an image frame on which the frame-interpolation will effectively work is predicted, and the frames are encoded by the dynamic image encoding device after this frame has been preferentially pulled-down. As a result, the reduction in the number of encoded bits due to extra addition of the encoded data for interpolation can be avoided and the generation of the encoded data on which the frame-interpolation will be apt to effectively work becomes possible even in the case that the frame-interpolation is performed by the decoding device alone.

Note that the structures and operations described in this embodiment are mere examples and can be appropriately modified and embodied with no limitation on the present invention.

As described above, the art is useful in encoding a dynamic image and is suitable, in particular, for coexisting maintenance of image quality with decreasing of the bit rate.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. An encoding method for encoding a sequence of image frames, the encoding method comprising the steps of:
selecting an image frame to be deleted from the plurality of image frames;
detecting motion vectors between a pair of image frames that are either previous to and next to the selected image frames;
deleting the selected image frame if the detected motion vectors meet a predetermined condition; and
encoding remainder of the image frames in which any of the image frames has been deleted by the deleting step.

2. The encoding method according to claim 1, wherein the deleting step deletes the selected image frame when the selected image frame is effective.

3. The encoding method according to claim 2, wherein the deleting step deletes the selected image frame on the basis of variations in the motion vectors o in the pair of image frames.

4. The encoding method according to claim 2, further comprising the steps of:
generating an interpolation frame on the basis of the detected motion vectors in the pair of image frames; and
calculating an interpolation error between the interpolation frame and the selected image frame to be deleted from the plurality of image frames;
wherein the deleting step deletes the selected image frame on the basis of the calculated interpolation error.

5. The encoding method according to claim 2, wherein the deleting step deletes the selected image frame on the basis of a degree of difficulty of encoding.

6. An encoding device for encoding a sequence of image frames comprising:
a selector for selecting an image frame to be deleted from the plurality of image frames;
a detector for detecting motion vectors between a pair of image frames that are either previous to and next to the selected image frames;
a processor for deleting the selected image frame if the detected motion vectors meet a predetermined condition; and
an encoder for encoding remainder of the image frames in which any of the image frames has been deleted by the processor.

7. The encoding device according to claim 6, wherein the processor deletes the selected image frame when the selected image frame is effective.

8. The encoding device according to claim 7, wherein the processor deletes the selected image frame on the basis of variations in the motion vectors o in the pair of image frames.

9. The encoding device according to claim 7, wherein the processor generates an interpolation frame on the basis of the detected motion vectors in the pair of image frames, calculates an interpolation error between the interpolation frame and the selected image frame to be deleted from the plurality of image frames and deletes the selected image frame on the basis of the calculated interpolation error.

10. The encoding device according to claim 7, wherein the processor deletes the selected image frame on the basis of a degree of difficulty of encoding.
